(19) United States
(12) Patent Application Publication
(10) Pub. No.: US 2015/0292867 A1
(43) Pub. Date: Oct. 15, 2015

(54) APPARATUS FOR DETECTING POSITION OF IMAGE PICKUP ELEMENT

(71) Applicant: SHARP KABUSHIKI KAISHA, Osaka (JP)

(72) Inventors: Norimichi Shigemitsu, Osaka-shi (JP); Hiroyuki Hanato, Osaka-shi (JP)

(21) Appl. No.: 14/438,889

(22) PCT Filed: Sep. 10, 2013
(86) PCT No.: PCT/JP2013/074387

§ 371 Date: Apr. 28, 2015

(30) Foreign Application Priority Data
Nov. 7, 2012 (JP) 2012-245696

(51) Int. Cl. G01B 11/14; H04N 5/225

(52) U.S. Cl. CPC G01B 11/14; H04N 5/2253; H04N 5/2254

(57) ABSTRACT

An image pickup element position detection device (10B) of the present invention detects a positional relationship between an image pickup element (2) and a lens (3) which are to be mounted on an optical system device and face each other. The image pickup element position detection device (10B) includes (i) an opposing mirror (5) which is disposed parallel to the image pickup element (2) so that the opposing mirror (5) and the image pickup element (2) are placed on opposite sides of the lens (3) and (ii) at least two side mirrors (11a and 11b) which face each other are disposed (i) perpendicularly to the opposing mirror (5) and (ii) on respective lateral sides of an area between the opposing mirror (5) and the lens (3).

### TECHNICAL FIELD

The present invention relates to an image pickup element position detection device that detects and adjusts a positional relationship between (i) an image pickup element which is to be mounted on an optical system device and (ii) a lens which is also to be mounted on the optical system and faces the image pickup element.

### BACKGROUND ART

Recently, in accordance with a rapid enhancement in resolution of camera modules, a highly accurate technique to mount an optical system and a light receiving element has been demanded.

Conventionally, for example, a mounting method has been employed in which mounting of an optical system and a light receiving element is carried out based on outer shapes and outer appearances of the optical system and the light receiving element. In recent years, it has been requested to carry out adjustment with accuracy higher than that of the technique based on the outer shapes and the outer appearances.

Under the circumstances, establishment of a process technology (active alignment: AA) is proceeding in which positional adjustment such as adjustment of an axis deviation and an inclination are carried out while maintaining an image pickup element in an output state, i.e., while capturing an image of a detection object.

For example, Patent Literature 1 discloses a method for manufacturing a camera module including the steps of: (i) holding, with use of a holding member that is movable to a desired position, a portion of a lens unit which portion is located on an opposite side of an image pickup element unit; (ii) detecting, based on an image of a recognition member exposed to an image pickup element unit side, a deviation amount by which an optical axis of an image pickup lens is deviated from a central axis of the holding member, the image of the recognition member having been captured by an image capturing device; (iii) shifting, by a shifting amount that has been corrected based on the deviation amount, the lens unit upward the image pickup element unit located on a predetermined position; and (iv) moving the lens unit toward the image pickup element unit so as to bond the lens unit to the image pickup element unit.

In this regard, Patent Literature 1 discloses that, by the above technique, it is possible to provide the method for manufacturing a camera module in which method the recognition member can be, as an alignment mark, accurately recognized without providing any special members and the optical axis of the image pickup lens and a center of the image pickup element can be surely matched with each other. That is, in this method, image recognition is carried out on the alignment mark so that a relative position between the image pickup lens and the image pickup element unit is adjusted.

Meanwhile, for example, Patent Literature 2 discloses a method for assembling a camera module including the steps of: (i) holding a main body of a camera module at a location above an image pickup element for detection while maintaining a space therebetween; (ii) adjusting, in accordance with an image signal supplied from the image pickup element for detection which image signal is obtained by radiating detection light above a lens contained in the main body of the camera module, a position of the main body of the camera module in terms of three axes directions and inclination; and (iii) fixing the main body of the camera module onto an upper edge of an adjustment frame that is horizontally held.

That is, in this method, the adjustment of the position of the main body of the camera module, which adjustment utilizes the image captured by the image pickup element for detection, is carried out while the main body of the camera module is fixed on the adjustment frame. After this step, the main body of the camera module is mounted on the image pickup element.

Furthermore, for example, Patent Literature 3 discloses another method for assembling a camera module that relates to a technique of alignment between a lens and an image pickup unit in which alignment technique an adjustment amount (i) is obtained based on a size and a distortion of an image and (ii) is then used in the alignment. In this method, the lens and the image pickup unit are separately adjusted and then mounted on the camera module while maintaining adjusted positions of the lens and the image pickup unit.

In the image pickup element position adjustment devices and the methods for adjusting a position of an image pickup element disclosed in Patent Literatures 1 through 3, captured image information is used for aligning an optical system. In these devices and methods, the image pickup element is used indirectly, in other words, an image pickup element to be actually mounted is not used. This causes processes to be complicated, and therefore there is a possibility of errors which may occur in mounting of an image pickup element.

Under the circumstances, establishment of a process technique is proceeding in which adjustment is carried out while maintaining an image pickup element, which is to be actually mounted, in an output state in which the image pickup element is capturing an image.

For example, Patent Literature 4 discloses a camera module manufacturing device which carries out adjustment by the steps below. First, a lens unit and an element unit are held by a lens holding mechanism and an element moving mechanism, respectively. Next, while a lens position determination plate and the lens holding mechanism, in which a position of the lens unit has been fixed, are moved on a second slide stage in a direction of an optical axis S, images of at least five measurement points that are displayed on a measurement chart are formed by an image-taking lens and the image pickup element captures images of focused positions of the measurement points. The images of the focused positions thus captured are compared with at least five adjustment points that are predetermined on a captured-image surface. Based on coordinates of the focused positions, adjustment positions of the measurement points are calculated by plane approximation. Then, on a third slide stage and a biaxial rotation stage, a position and an inclination of the element unit are adjusted so that the focused positions of the measurement points agree with respective adjustment points.

In other words, in this method, defocus characteristics of a central image and a peripheral image of the captured-image surface are obtained so that an adjustment amount is calculated based on inclinations of an image-forming position and an image plane.

Further, for example, Patent Literature 5 discloses an image pickup element inclination measurement device in which a measurement chart moves in a direction of an optical axis of an image-taking lens, a fixed image pickup element captures multiple times images of the measurement chart thus moving, and then an inclination of the fixed image pickup element is quantitatively detected with use of a peak value of a contrast characteristic curve that has been obtained by image data of the measuring chart. In other words, in this method, an inclination of a sensor surface with respect to an image plane is detected based on a defocus characteristic, and the defocus characteristic is obtained by moving an object.

As described above, in the techniques disclosed in Patent Literatures 4 and 5, the optical system is directly adjusted with respect to the image pickup element kept in the output state.

In other words, in Patent Literature 4, the captured-image surface is obtained, the inclination of the image surface is calculated, and then such information is reflected in the adjustment amount. Meanwhile, in Patent Literature 5, the defocus characteristic with respect to changes of the object surface is obtained, the inclination of the image surface is calculated, and then such information is reflected in the adjustment amount.

Each of the methods can be said as useful for highly accurately adjusting an inclination of an image surface and for achieving an image surface detection device that is useful and applicable to a configuration of each module.

### CITATION LIST

Patent Literature 1

Japanese Patent Application Publication

Tokukai, No. 2012-27063 (Publication Date: Feb. 9, 2012)

Patent Literature 2

Japanese Patent Application Publication

Tokukai, No. 2011-175019 (Publication Date: Sep. 8, 2011)

Patent Literature 3

Japanese Patent Application Publication

Tokukai, No. 2011-133509 (Publication Date: Jul. 7, 2011)

Patent Literature 4

Japanese Patent Application Publication

Tokukai, No. 2009-302837 (Publication Date: Dec. 24, 2009)

Patent Literature 5

Japanese Patent Application Publication

Tokukai, No. 2006-319544 (Publication Date: Nov. 24, 2006)

### SUMMARY OF INVENTION

### Technical Problem

However, the conventional image pickup element position adjustment devices disclosed in Patent Literatures 4 and 5 have a problem in which, in a case where there is an axis deviation between an object and an optical system, the axis of the optical system also deviates, by an amount corresponding to the axis deviation, from an axis of an image pickup system, so that an inclination of an image surface with respect to an image height to be adjusted may not be reflected.

The present invention is attained in view of the above problem. An objective of the present invention is to provide an image pickup element position detection device that is compact and can highly accurately detect, based on image pickup information obtained with use of an image pickup element to be actually mounted, at least an axis deviation between an optical system and the image pickup element.

### Solution to Problem

In order to attain the above object, an image pickup element position detection device according to one aspect of the present invention is configured to detect a positional relationship between an image pickup element and a lens which are to be mounted on an optical system device, the lens facing the image pickup element, the image pickup element position detection device including: an opposing mirror which is disposed parallel to the image pickup element, the opposing mirror and the image pickup element being placed on opposite sides of the lens, the image pickup element capturing an opposing mirror reflection image of the lens, the opposing mirror reflection image being an image of the lens which is reflected by the opposing mirror.

According to the configuration described above, the opposing mirror is disposed parallel to the image pickup element, and the opposing mirror and the image pickup element are placed on opposite sides of the lens so that the opposing mirror reflection image, which is reflected by the opposing mirror, of the lens is captured on the image pickup element.

In doing so, for example, in a case where an optical axis of the lens deviates from a center of the image pickup element, such a deviation between the optical axis of the lens and the center of the image pickup element appears in the opposing mirror reflection image of the lens which image is captured on the image pickup element. As a result, it is possible to easily detect the deviation between the optical axis of the lens and the center of the image pickup element.

Further, this detection is carried out based on image pickup information that has been obtained with use of the image pickup element which is to be actually mounted, i.e., a positional relationship between the image pickup element and the lens, which are to be actually mounted, is directly reflected in the detection. Therefore, it can be said that accuracy in the detection is sufficiently high. Furthermore, the image pickup element position detection device merely includes the opposing mirror, so that the image pickup element position detection device is compact.

Therefore, it is possible to provide the image pickup element position detection device that is compact and can highly accurately detect at least an axis deviation between the optical system and the image pickup element based on image pickup information obtained with use of the image pickup element which is to be actually mounted.

### Advantageous Effects of Invention

The image pickup element position detection device according to one aspect of the present invention brings about an effect of providing an image pickup element position detection device that is compact and can highly accurately detect, based on image pickup information obtained with use of an image pickup element to be actually mounted, at least an axis deviation between an optical system and the image pickup element.

### BRIEF DESCRIPTION OF DRAWINGS

FIG. 1 is a view in which (a) is a lateral view illustrating a configuration of an image pickup element position detection device of Embodiment 1 of the present invention, and (b) is a schematic view illustrating, when viewed from front, an image of a lens which image appears on an image pickup element of the image pickup element position detection device.

FIG. 2 is a view in which (a) is a lateral view illustrating a detection principle of an image pickup element position detection device employing a conventional chart image capturing method and (b) is a lateral view illustrating a detection principle of the image pickup element position detection device of Embodiment 1.

FIG. 3 is a lateral view illustrating a configuration of an image pickup element position detection device of Embodiment 2 of the present invention.

FIG. 4 is a schematic view illustrating, when viewed from front, an image of a lens which image appears on an image pickup element of the image pickup element position detection device.

FIG. 5 is a lateral view illustrating a focus position when an image surface of the image pickup element position detection device is inclined with respect to a light receiving surface of the image pickup element.

FIG. 6 is a lateral view illustrating a configuration in a case where an axis deviation/inclination adjustment section is provided in the image pickup element position detection device of Embodiment 2.

FIG. 7 is a lateral view illustrating a comparison in size between the image pickup element position detection device and an image pickup element position detection device employing a conventional chart image capturing method.

FIG. 8 is a lateral view illustrating an operation of moving an opposing mirror and side mirrors forward and backward with use of a mirror moving section of the image pickup element position detection device.

FIG. 9 is a view in which (a) is a plan view illustrating a disposition pattern of the opposing mirror and the side mirrors in the image pickup element position detection device and (b) is a plane view illustrating another disposition pattern of the opposing mirror and the side mirrors in the image pickup element position detection device.

FIG. 10 is a lateral view illustrating a configuration of an image pickup element position detection device of Embodiment 3 of the present invention.

FIG. 11 is a view in which (a), (b) and (c) are plan views illustrating configurations of detection patterns of the image pickup element position detection device and (d) is a graph illustrating luminance distribution on an edge of a colored section of the detection patterns.

FIG. 12 is a view in which (a) and (b) are end views illustrating the configurations of the detection patterns of the image pickup element position detection device.

### DESCRIPTION OF EMBODIMENTS

### Embodiment 1

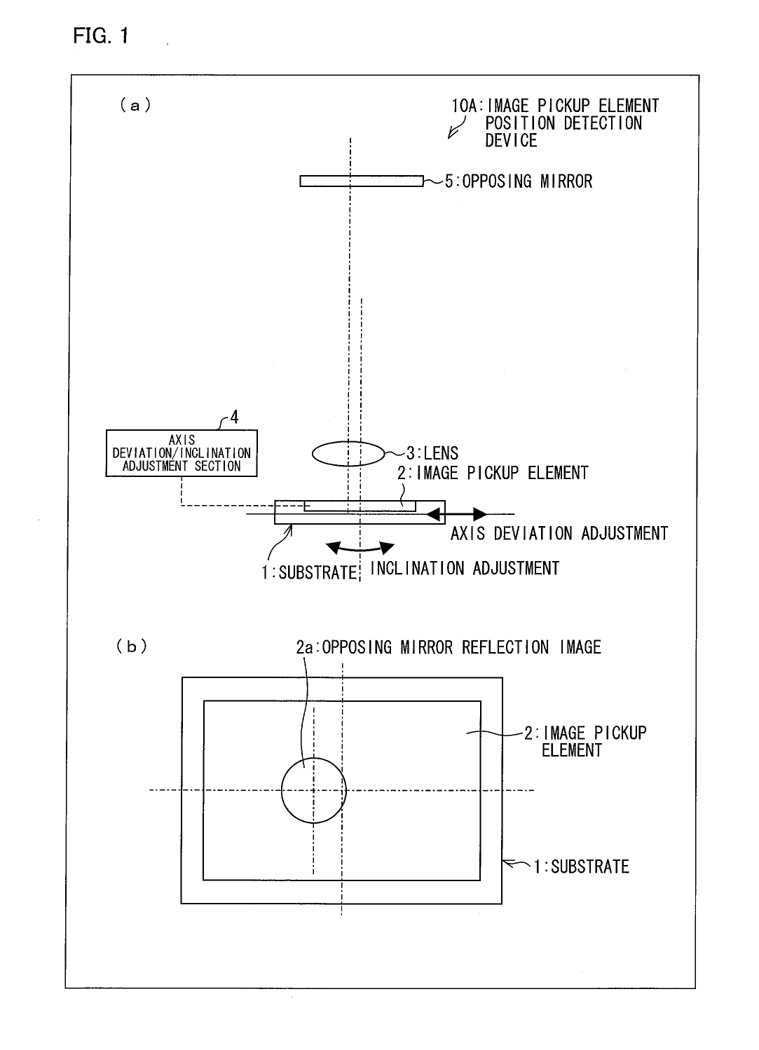

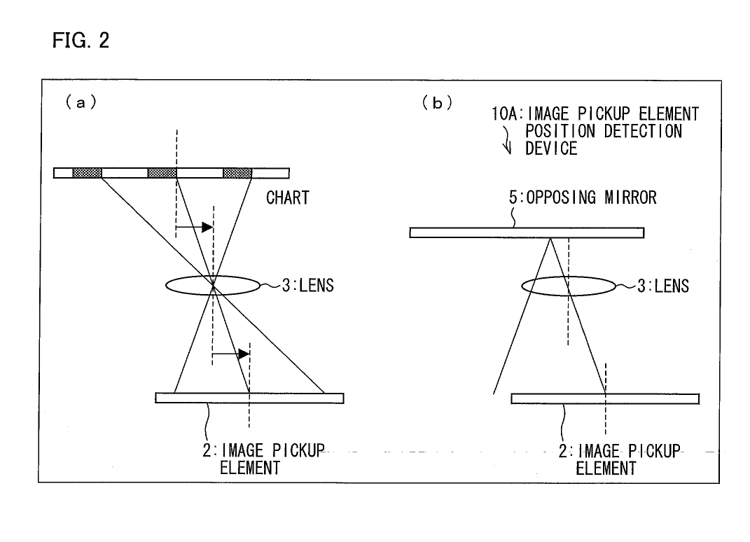

The following discusses Embodiment 1 of the present invention with reference to FIGS. 1 and 2.

An image pickup element position detection device of Embodiment 1 is configured to detect at least a positional relationship (i.e., an axis deviation and an inclination) between (i) an image pickup element which is to be mounted on an optical system device and (ii) a lens which is also to be mounted on the optical system device and faces the image pickup element.

(Configuration)

The following discusses a configuration of the image pickup element position detection device of Embodiment 1 with reference to (a) and (b) of FIG. 1. (a) of FIG. 1 is a lateral view illustrating the configuration of the image pickup element position detection device of Embodiment 1. (b) of FIG. 1 is a schematic view illustrating, when viewed from front, an image of a lens which image appears on an image pickup element. In (b) of FIG. 1, the image of the lens has a circular shape as an example. Note, however, that, since (b) of FIG. 1 is merely a schematic view, the shape of the image of the lens is not limited to the circular shape.

In an image pickup element position detection device 10A of Embodiment 1, an image pickup element 2 is mounted on a substrate 1, and a lens 3 is located above the image pickup element 2 (see (a) of FIG. 1). The lens 3 is supported by an axis deviation/inclination adjustment section 4 which serves as an adjustment section, a parallel movement section, and a rotation section. In the axis deviation/inclination adjustment section 4, the lens 3 is moved horizontally to the image pickup element 2 in X-axis and Y-axis directions and/or is rotated so that an inclination angle of the lens 3 with respect to the image pickup element 2 is adjusted. Further, an opposing mirror 5 is disposed parallel to the image pickup element 2 so that the opposing mirror 5 and the image pickup element 2 are placed on opposite sides of the lens 3. Furthermore, the image pickup element 2 captures an opposing mirror reflection image 2a of the lens 3 which opposing mirror reflection image 2a is an image of the lens 3 reflected by the opposing mirror 5.

(Methods for Detecting and Adjusting Axis Deviation)

The following discusses a method for detecting an axis deviation between a central position of the image pickup element 2 and an optical axis of the lens 3 in the image pickup element position detection device 10A configured as described above.

As illustrated in (a) of FIG. 1, in the image pickup element position detection device 10A, an opposing mirror 5 is disposed parallel to the image pickup element 2 so that the opposing mirror 5 and the image pickup element 2 are placed on opposite sides of the lens 3. An image of the lens 3 is captured in this state and consequently the image pickup element 2 captures an opposing mirror reflection image 2a of the lens 3 as illustrated in (b) of FIG. 1.

In doing so, for example, in a case where an optical axis of the lens 3 deviates from a center of the image pickup element 2, such a deviation between the optical axis of the lens 3 and the center of the image pickup element 2 appears in the opposing mirror reflection image 2a of the lens 3 which image is captured on the image pickup element 2. As a result, it is possible to easily detect the deviation between the optical axis of the lens 3 and the center of the image pickup element 2.

Further, this detection is carried out based on image pickup information that has been obtained with use of the image pickup element 2 which is to be actually mounted on an optical system device, i.e., a positional relationship between the image pickup element 2 and the lens 3, which are to be actually mounted, is directly reflected in the detection. Therefore, it can be said that accuracy in the detection is sufficiently high. Furthermore, the image pickup element position detection device 10A merely includes the opposing mirror 5, so that the image pickup element position detection device 10A is compact.

Therefore, it is possible to provide the image pickup element position detection device 10A having a compact size and a method for detecting a position of an image pickup element that can highly accurately detect at least an axis deviation between an optical system and the image pickup element 2 based on the image pickup information obtained with use of the image pickup element 2 which is to be actually mounted.

The image pickup element position detection device 10A of Embodiment 1 further includes an axis deviation/inclination adjustment section 4. Therefore, it is possible to easily adjust a parallel eccentricity between the lens 3 and the image pickup element 2 by, for example, moving the image pickup element 2 relatively to the lens 3 in parallel with the X-axis and Y-axis directions by the use of the axis deviation/inclination adjustment section 4. In Embodiment 1, the image pickup element 2 is moved parallel to the lens 3, i.e., in the X-axis and Y-axis directions. Note, however, that Embodiment 1 is not limited to this and can be alternatively configured such that the lens 3 is moved parallel to the image pickup element 2, i.e., in the X-axis and Y-axis directions. Note also that, as the configuration of the image pickup element position detection device 10A, a configuration in which the image pickup element 2 is moved while the lens 3 is fixed seems to be a simpler configuration. In some cases, however, it may be more useful to reverse or mix the above arrangements depending on, for example, an adjustment method and/or a detection method.

Conventionally, in order to adjust the deviation between the optical axis of the lens 3 and the center of the image pickup element 2, for example, there is a known method as illustrated in (a) of FIG. 2 in which method a chart is disposed on a position opposing to a lens and an image of the chart thus disposed is captured so that a deviation between an optical axis of the lens and a center of an image pickup element is adjusted. However, in this method, in a case where there is an axis deviation between the chart and a lens system, it cannot be said that the axis deviation is solved even if a central image of the chart agrees with a center of a light receiving surface of the image pickup element. Further, in such a case, an evaluation is carried out on an image height which is not an intended image height, and it is therefore impossible to appropriately adjust an inclination with respect to the intended image height.

Meanwhile, in Embodiment 1, the deviation between the opposing mirror 5 and the lens system does not affect a position of the opposing mirror reflection image 2a on the image pickup element 2 as illustrated in (b) of FIG. 2. This makes it possible to easily carry out adjustment so that a center of the opposing mirror reflection image 2a of the lens 3 on the image pickup element 2 agrees with the center of the image pickup element 2 without taking into consideration the axis deviation between the opposing mirror 5 and the lens system.

### Embodiment 2

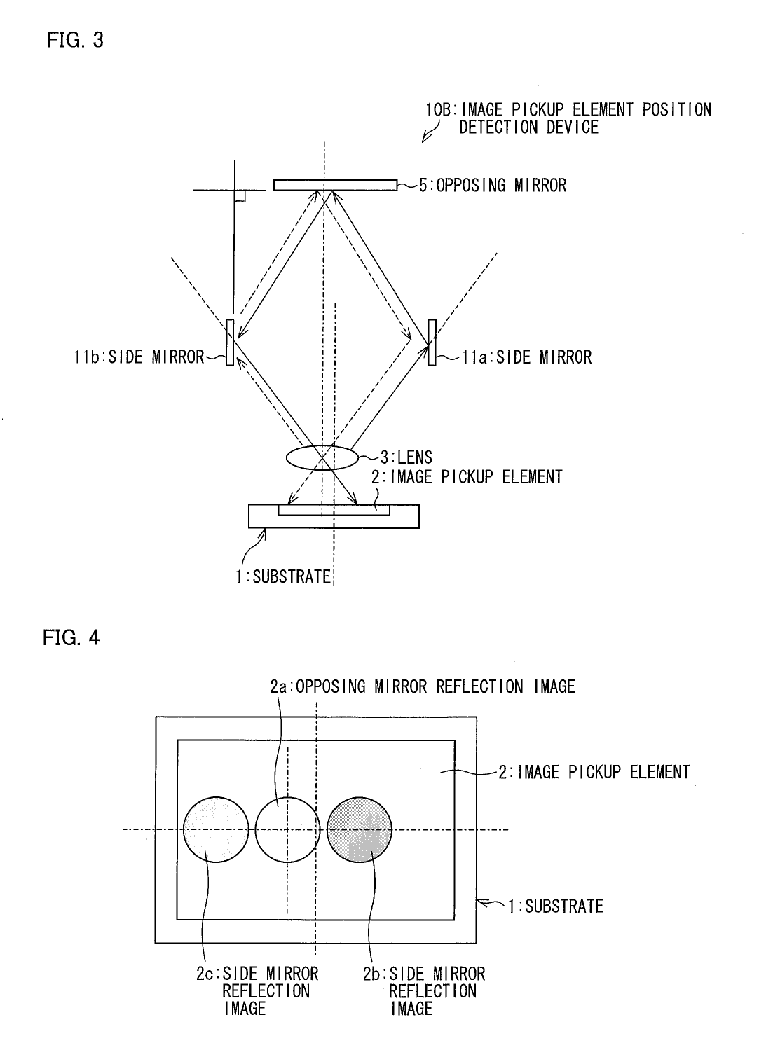

The following discusses Embodiment 2 of the present invention with reference to FIGS. 3 through 9. Configurations which are not described in Embodiment 2 are the same as those described in Embodiment 1. Furthermore, for convenience of explanation, members respectively having identical functions as those illustrated in figures of Embodiment 1 are given the same reference numerals, and explanations of such members are omitted.

An image pickup element position detection device 10B of Embodiment 2 differs from the configuration of the image pickup element position detection device 10A of Embodiment 1 in that the image pickup element position detection device 10B further includes side mirrors.

(Configuration)

The following discusses a configuration of the image pickup element position detection device of Embodiment 2 with reference to FIGS. 3 and 4. FIG. 3 is a lateral view illustrating the configuration of the image pickup element position detection device 10B of Embodiment 2. FIG. 4 is a schematic view illustrating, when viewed from front, an image of a lens which image appears on an image pickup element. In FIG. 4, the image of the lens has a circular shape as an example. Note, however, that, since FIG. 4 is merely a schematic view, the shape of the image of the lens is not limited to the circular shape.

In addition to the configuration of the image pickup element position detection device 10A of Embodiment 1, as illustrated in FIG. 3, the image pickup element position detection device 10B of Embodiment 2 further includes at least side mirrors 11a and 11b which face each other and are disposed (i) perpendicularly to the opposing mirror 5 and (ii) on respective lateral sides of an area between the opposing mirror 5 and the lens 3.

(Contrast Evaluation and Method for Adjusting Inclination)

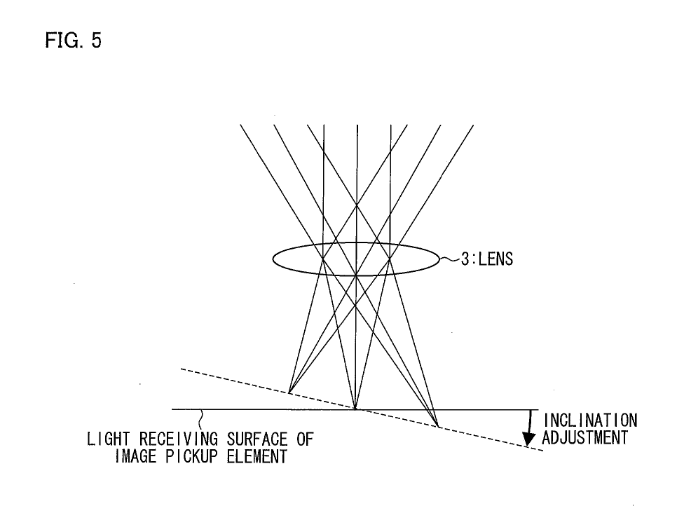

The following further discusses, with reference to FIGS. 3 through 5, a method for adjusting an inclinations of the image pickup element 2 with respect to the lens 3 in the image pickup element position detection device 10B configured as described above. FIG. 5 is a lateral view illustrating a focus position when an image surface in the image pickup element position detection device is inclined with respect to a light receiving surface of the image pickup element.

As illustrated in FIGS. 3 and 4, the image pickup element 2 captures (i) an opposing mirror reflection image 2a which is an image of the lens 3 reflected by an opposing mirror 5; (ii) a side mirror reflection image 2b which is an image of the lens 3 reflected by the side mirror 11a, by the opposing mirror 5, and by the side mirror 11b in this order; and (iii) a side mirror reflection image 2c which is an image of the lens 3 reflected by the side mirror 11b, by the opposing mirror 5, and by the side mirror 11a in this order.

In other words, the image pickup element 2 of Embodiment 2 further captures the side mirror reflection images 2b and 2c of the lens 3 reflected by the side mirrors 11a and 11b, and the opposing mirror 5. Note that these side mirror reflection images 2b and 2c appear on both sides of the opposing mirror reflection image 2a.

In this case, for example, a focus position is deviated due to an inclination of the light receiving surface of the image pickup element 2 with respect to the image surface, so that a contrast can be degraded and/or a difference in contrast can be seen. FIG. 5 shows a state in which the focus position is deviated due to the inclination of the light receiving surface of the image pickup element 2 with respect to the image surface. Therefore, it is possible to appropriately adjust the inclination based on such contrast evaluations as described above.

Further, these contrast evaluations are carried out based on image pickup information that has been obtained with use of the image pickup element 2 which is to be actually mounted on an optical system device, i.e., a positional relationship between the image pickup element 2 and the lens 3, which are to be actually mounted, is directly reflected in the contrast evaluations. Therefore, it can be said that detection accuracy in the contrast evaluation is sufficiently high. Furthermore, the image pickup element position detection device 10B merely includes the side mirrors 11a and 11b between the opposing mirror 5 and the lens 3, so that the image pickup element position detection device 10B is compact.

Therefore, it is possible to provide the image pickup element position detection device 10B having a compact size and a method for detecting a position of an image pickup element that can highly accurately carry out the contrast evaluations and appropriately adjust the inclination based on the image pickup information obtained with use of the image pickup element 2 which is to be actually mounted.

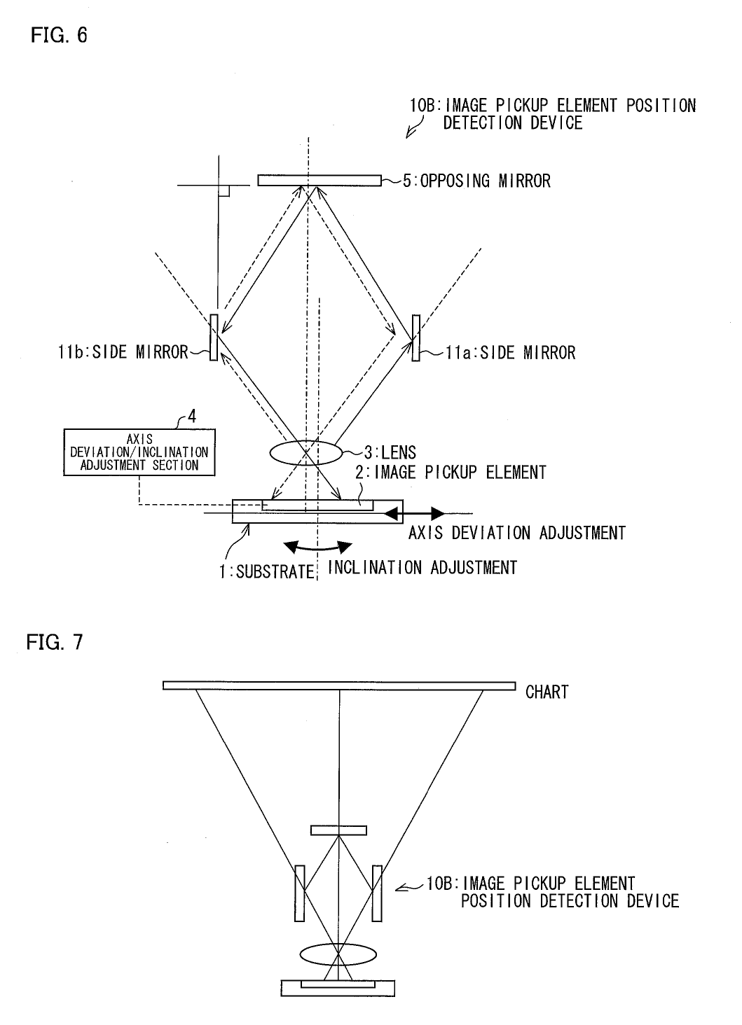

Here, similarly to the image pickup element position detection device 10A of Embodiment 1, the image pickup element position detection device 10B of Embodiment 2 can further include the axis deviation/inclination adjustment section 4 (See FIG. 6). Therefore, it is possible to easily adjust an inclination eccentricity between the lens 3 and the image pickup element 2 by, for example, rotating the image pickup element 2 relatively to the lens 3 by the use of the axis deviation/inclination adjustment section 4. In Embodiment 2, the image pickup element 2 is rotated with respect to the lens 3. Note, however, that Embodiment 2 is not limited to this and can be alternatively configured such that the lens 3 is rotated with respect to the image pickup element 2. Note also that, as the configuration of the image pickup element position detection device 10B, a configuration in which the image pickup element 2 is moved while the lens 3 is fixed seems to be a simpler configuration. In some cases, however, it may be more useful to reverse or mix the above arrangements depending on, for example, an adjustment method and/or a detection method.

The image pickup element position detection device 10B of Embodiment 2 can form an image on the image pickup element 2 while a distance between an object and the image pickup element 2 is made to approximately half as compared with that in the conventional chart image capturing method (see FIG. 7). This is because a virtual image of a mirror appears on a position at a distance that is twice as long as a distance between an object and the mirror. Therefore, it is possible to provide the image pickup element position detection device 10A that is more compact as compared with a conventional technique.

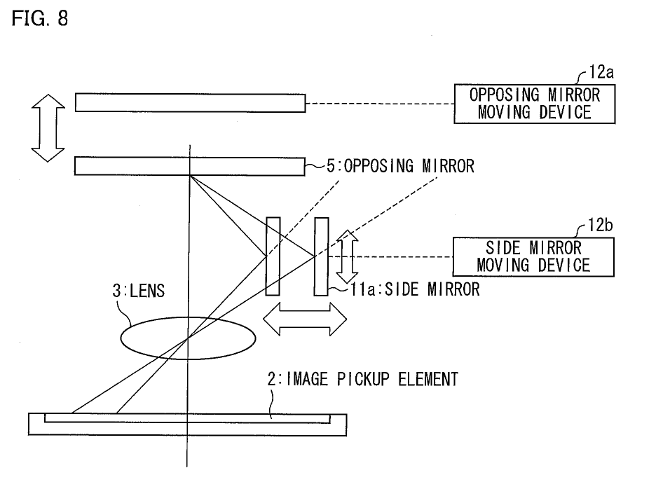

Next, as illustrated in FIG. 8, the image pickup element position detection device 10B of Embodiment 2 further includes (i) an opposing mirror moving device 12a as an opposing mirror moving section that moves the opposing mirror 5 forward and backward; and (ii) a side mirror moving device 12b as a side mirror moving section that moves the side mirrors 11a and 11b forward, backward, rightward, and leftward.

With the configuration, the opposing mirror 5 is moved forward and backward and the side mirrors 11a and 11b are each moved forward, backward, rightward, and leftward. This brings about an effect of enhancing versatility of the image pickup element position detection device 10B.

Generally, in using an image capture chart, it is necessary to determine a size and a pattern disposition of the image capture chart in accordance with (i) an object distance (i.e., a distance between subjects) to be used for adjustment and (ii) an evaluation image height. On the other hand, in a case where the opposing mirror moving device 12a and the side mirror moving device 12b illustrated in FIG. 8 are used, an arbitrary object distance can be obtained by adjusting forward and backward positions of the opposing mirror 5 and the side mirrors 11a and 11b. Moreover, it is possible to set the evaluation image height to be an arbitrary evaluation image height by adjusting the positions of the side mirrors 11a and 11b.

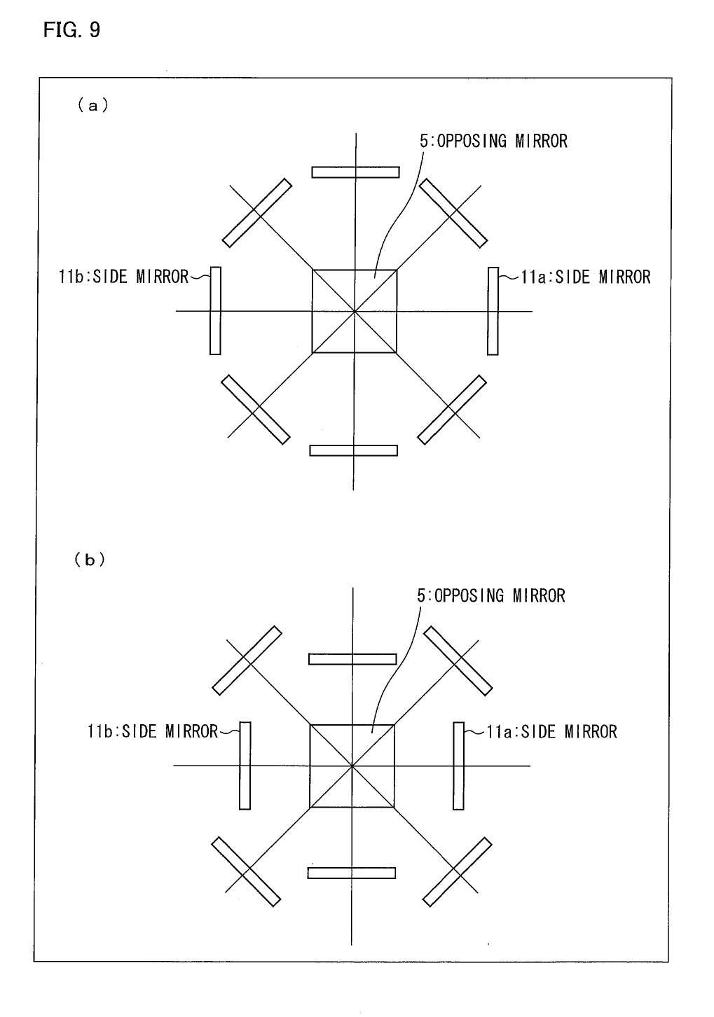

In the above explanation, it has been described that at least one pair of side mirrors 11a and 11b is provided. However, as illustrated in (a) and (b) of FIG. 9, it is preferable that the side mirrors 11a and 11b be provided at least in four directions. Note that, it is also possible to provide the side mirrors 11a and 11b in eight directions or in diagonal directions corresponded to an aspect ratio of the image pickup element 2. That is, the number of peripheral image heights to be evaluated can be increased to an extent that mirrors do not overlap with each other. There may be a case in which it is sufficient to provide mirrors in four directions and a case in which it is necessary to provide mirrors in eight directions. It is also possible to change an evaluation image height for each of the directions. For example, it is possible to set the evaluation image height in vertical and horizontal directions to be h=0.5 and the evaluation image height in the diagonal directions to be h=0.7.

### Embodiment 3

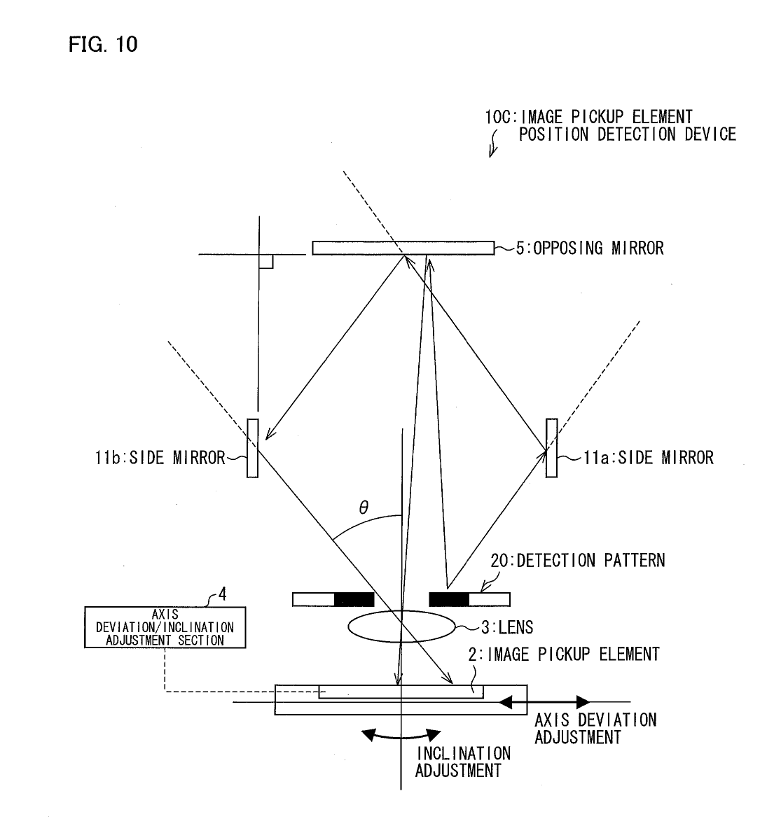

The following further discusses Embodiment 3 of the present invention with reference to FIGS. 10 through 12. Configurations which are not described in Embodiment 3 are the same as those described in Embodiment 2. Furthermore, for convenience of explanation, members respectively having identical functions as those illustrated in figures of Embodiment 2 are given the same reference numerals, and explanations of such members are omitted.

An image pickup element position detection device 10C of Embodiment 3 differs from the configuration of the image pickup element position detection device 10B of Embodiment 2 in that the image pickup element position detection device 10C further includes a detection pattern.

(Configuration)

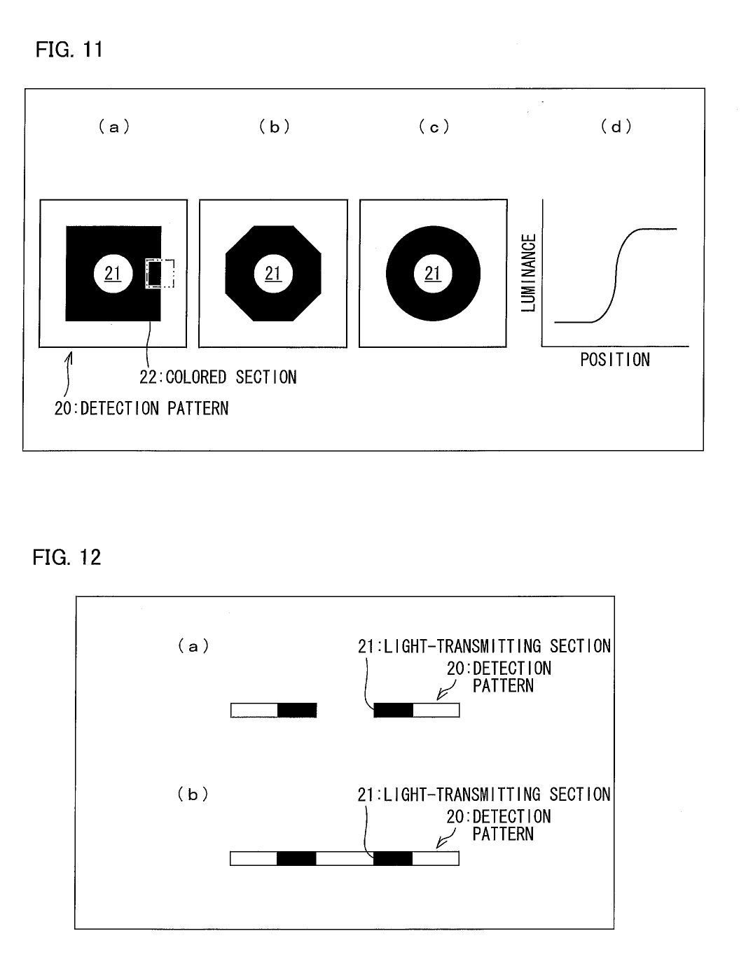

The following discusses a configuration of the image pickup element position detection device of Embodiment 3 with reference to FIGS. 10 through 12. FIG. 10 is a lateral view illustrating the configuration of the image pickup element position detection device 10C of Embodiment 3. Each of (a), (b) and (c) of FIG. 11 is a plan view illustrating a configuration of a detection pattern in the image pickup element position detection device. (d) of FIG. 11 is a graph illustrating luminance distribution on an edge of a colored section of the detection pattern. Each of (a) and (b) of FIG. 12 is an end view illustrating the configuration of the detection pattern in the image pickup element position detection device.

In addition to the configuration of the image pickup element position detection device 10B of Embodiment 2, the image pickup element position detection device 10C of Embodiment 3 includes a detection pattern 20 which serves as a detection object and is disposed parallel to an opposing mirror 5 and between a lens 3 and the opposing mirror 5 (see FIG. 10).

As illustrated in (a), (b), and (c) of FIG. 11, the detection pattern 20 is made of a flat board and includes (i) a light-transmitting section 21 that has a circular shape and is located in a center of the flat board and (ii) a colored section 22 surrounding the light-transmitting section 21. The light-transmitting 21 can have, as illustrated in (a) of FIG. 12, a hole located in the center of the flat board or can be, as illustrated in (b) of FIG. 12, made of a light-transmitting member having a circular shape.

Further, the colored section 22 is, for example, made of a black-colored member so that a difference in luminance distribution appears on an edge of the colored section 22 as illustrated in (d) of FIG. 11.

Note that the colored section 22 can have a square shape as illustrated in (a) of FIG. 11, a polygonal shape as illustrated in (b) of FIG. 11, or a circular shape as illustrated in (c) of FIG. 11.

(Methods for Detecting and Adjusting Inclination with Use of Contrast Evaluation)

The following discusses methods for detecting and adjusting an inclination with use of a contrast evaluation in the image pickup element position detection device 10C configured as described above.

In the image pickup element position detection device 10C configured as described above, three images, i.e., an opposing mirror reflection image 2a and side mirror reflection images 2b appear on an image pickup element 2. The opposing mirror reflection image 2a is an image of the detection pattern 20 reflected by an opposing mirror 5, and the side mirror reflection images 2b are images of the detection pattern 20 and appear on both side of the opposing mirror reflection image 2a.

The detection pattern 20 is a colored member and therefore, for example, in a case where the lens 3 is inclined with respect to the image pickup element 2, a difference in contrast occurs in the two side mirror reflection images 2b of the detection pattern 20.

This makes it possible to easily detect an inclination of the lens 3 with respect to the image pickup element 2.

Further, this detection is carried out based on image pickup information that has been obtained with use of the image pickup element 2 which is to be actually mounted on an optical system device, i.e., a positional relationship between the image pickup element 2 and the lens 3, which are to be actually mounted, is directly reflected in the detection. Therefore, it can be said that accuracy in the detection is sufficiently high. Furthermore, the image pickup element position detection device 10C merely includes the side mirrors 11a and 11b between the opposing mirror 5 and the lens 3, so that the image pickup element position detection device 10C is compact.

Therefore, it is possible to provide the image pickup element position detection device 10C having a compact size and a method for detecting a position of an image pickup element that can highly accurately detect an inclination of an optical system with respect to the image pickup element 2 based on image pickup information obtained with use of the image pickup element 2 which is to be actually mounted.

Here, similarly to the image pickup element position detection device 10A of Embodiment 1, the image pickup element position detection device 10C of Embodiment 3 further includes the axis deviation/inclination adjustment section 4. Therefore, it is possible to easily adjust an inclination eccentricity between the lens 3 and the image pickup element 2 by rotating the lens 3 with respect to the image pickup element 2 by the use of the axis deviation/inclination adjustment section 4.

Note, the present invention is not limited to the description of the embodiments above, but may be altered within the scope of the claims. An embodiment derived based on a proper combination of technical means disclosed in different embodiments is also encompassed in the technical scope of the present invention.

[Main Points]

In order to attain the above object, an image pickup element position detection device 10A according to one aspect of the present invention is configured to detect a positional relationship between an image pickup element 2 and a lens 3 which are to be mounted on an optical system device, the lens 3 facing the image pickup element 2, the image pickup element position detection device 10A including: an opposing mirror 5 which is disposed parallel to the image pickup element 2, the opposing mirror 5 and the image pickup element 2 being placed on opposite sides of the lens 3, the image pickup element 2 capturing an opposing mirror reflection image 2a of the lens 3, the opposing mirror reflection image being an image of the lens 3 which is reflected by the opposing mirror 5.

In order to attain the above object, a detection method according to one aspect of the present invention for detecting a position of an image pickup element is a method for adjusting a positional relationship between the image pickup element 2 which is to be mounted on the optical system device and the lens 3 which is also to be mounted on the optical system device and faces the image pickup element 2, the method includes the steps of: (i) disposing the opposing mirror 5 so that the opposing mirror 5 lies parallel to the image pickup element 2, and the opposing mirror 5 and the image pickup element 2 are placed on opposite sides of the lens 3; and (ii) capturing, with use of the image pickup element 2, an image of the opposing mirror reflection image 2a which is an image of the lens 3 which is reflected by the opposing mirror 5.

According to the configuration described above, the opposing mirror 5 is disposed parallel to the image pickup element 2, and the opposing mirror 5 and the image pickup element 2 are placed on opposite sides of the lens 3 so that the opposing mirror reflection image 2a, which is reflected by the opposing mirror 5, of the lens 3 is captured on the image pickup element 2.

In doing so, for example, in a case where an optical axis of the lens 3 deviates from a center of the image pickup element 2, such a deviation between the optical axis of the lens 3 and the center of the image pickup element 2 appears in the opposing mirror reflection image 2a of the lens 3 which image is captured on the image pickup element 2. As a result, it is possible to easily detect the deviation between the optical axis of the lens 3 and the center of the image pickup element.

Further, this detection is carried out based on image pickup information that has been obtained with use of the image pickup element 2 which is to be actually mounted, i.e., a positional relationship between the image pickup element 2 and the lens 3, which are to be actually mounted, is directly reflected in the detection. Therefore, it can be said that accuracy in the detection is sufficiently high. Furthermore, the image pickup element position detection device 10A merely includes the opposing mirror 5, so that the image pickup element position detection device 10A is compact.

Therefore, it is possible to provide the image pickup element position detection device 10A having a compact size and a method for detecting a position of an image pickup element that can highly accurately detect at least an axis deviation between the optical system and the image pickup element 2 based on image pickup information obtained with use of the image pickup element 2 to be actually mounted.

An image pickup element position detection device 10B according to one aspect of the present invention includes: at least two side mirrors 11a and 11b which face each other and are disposed (i) perpendicularly to the opposing mirror 5 and (ii) on respective lateral sides of an area between the opposing mirror 5 and the lens 3, the image pickup element 2 capturing side mirror reflection images 2b and 2c of the lens 3, the side mirror reflection image 2b of the lens 3 being an image of the lens 3 which is reflected by the side mirror 11a, by the opposing mirror 5, and by the side mirror 11b in this order, and the side mirror reflection image 2c of the lens 3 being an image of the lens 3 which is reflected by the side mirror 11b, by the opposing mirror 5, and by the side mirror 11a in this order.

A method for detecting a position of an image pickup element according to one aspect of the present invention can include the steps of: (i) disposing at least side mirrors 11a and 11b, which face each other, (a) perpendicularly to the opposing mirror 5 and (b) on respective lateral sides of an area between the opposing mirror 5 and the lens 3; and (ii) capturing, with use of the image pickup element 2, the side mirror reflection images 2b and 2c of the lens 3, the side mirror reflection image 2b of the lens 3 being the image of the lens 3 which is reflected by the side mirror 11a, by the opposing mirror 5, and by the side mirror 11b in this order, and the side mirror reflection image 2c of the lens 3 being the image of the lens 3 which is reflected by the side mirror 11b, by the opposing mirror 5, and by the side mirror 11a in this order.

As described above, the image pickup element 2 captures the side mirror reflection images 2b and 2c of the lens 3, the side mirror reflection image 2b of the lens 3 being the image of the lens 3 which is reflected by the side mirror 11a, by the opposing mirror 5, and by the side mirror 11b in this order, and the side mirror reflection image 2c of the lens 3 being the image of the lens 3 which is reflected by the side mirror 11b, by the opposing mirror 5, and by the side mirror 11a in this order. Note that these side mirror reflection images 2b and 2c appear on both sides of the opposing mirror reflection image 2a.

Here, for example, in a case where an image surface is inclined with respect to a light receiving surface of the image pickup element 2, a contrast can be degraded and/or a difference in contrast can be seen. Therefore, it is possible to appropriately adjust the inclination based on such contrast evaluations as described above.

Further, it is preferable that the image pickup element position detection device 10B according to one aspect of the present invention include a detection object (detection pattern 20) located between the lens 3 and the opposing mirror 5, the detection object (i) being colored, (ii) having a light-transmitting section 21, and (iii) being disposed parallel to the opposing mirror 5.

With the configuration, three images appear on the image pickup element 2. That is, (i) an opposing mirror reflection image which is an image of the detection object (detection pattern 20) reflected by the opposing mirror 5 and (ii) two side mirror reflection images on both sides of the opposing mirror reflection image appear on the image pickup element 2.

Here, the detection object (detection pattern 20) is a colored member and therefore, for example, in a case where the lens 3 is inclined with respect the image pickup element 2, a difference in contrast occurs in the two side mirror reflection images of the detection object (detection pattern 20).

This makes it possible to easily detect an inclination of the lens 3 with respect to the image pickup element 2.

Furthermore, it is preferable that the image pickup element detection devices 10A and 10B according to one aspect of the present invention each include an adjustment section (axis deviation/inclination adjustment section 4) that relatively adjusts positions of the image pickup element 2 and the lens 3.

This makes it possible to easily adjust, with use of the adjustment section (axis deviation/inclination adjustment section 4), an axis deviation between the lens 3 and the image pickup element 2 and the inclination of the lens 3 with respect to the image pickup element 2.

Further, in the image pickup element position detection device 10A according to one aspect of the present invention, the adjustment section (axis deviation/inclination adjustment section 4) can be made up of a parallel movement section that relatively moves the image pickup element 2 and the lens 3 in parallel.

This makes it possible to easily adjust a parallel eccentricity between the lens 3 and the image pickup element 2.

Furthermore, in the image pickup element position detection device 10B according to one aspect of the present invention, the adjustment section (axis deviation/inclination adjustment section 4) can be made up of a rotation section that rotates the lens 3 or the image pickup element 2 so as to adjust the inclination of the lens 3 with respect to the image pickup element 2.

This makes it possible to easily adjust an inclination eccentricity between the lens 3 and the image pickup element 2.

The image pickup element position detection device 10B according to one aspect of the present invention can include (i) an opposing mirror moving section (opposing mirror moving device 12a) that moves the opposing mirror 5 forward and backward; and (ii) a side mirror moving section (side mirror moving device 12b) that moves the side mirrors 11a and 11b forward, backward, rightward, and leftward.

With the configuration, the opposing mirror 5 is moved forward and backward and the side mirrors 11a and 11b are each moved forward, backward, rightward, and leftward. This brings about an effect of enhancing versatility of the image pickup element position detection device 10B.

Generally, in using an image capture chart, it is necessary to determine a size and a pattern disposition of the image capture chart in accordance with (i) an object distance (i.e., a distance between subjects) to be used for adjustment and (ii) an evaluation image height. On the other hand, in a case where the opposing mirror moving device 12a and the side mirror moving device 12b of the present embodiment are used, an arbitrary object distance can be obtained by adjusting forward and backward positions of the opposing mirror 5 and/or by adjusting forward, backward, rightward, and leftward positions of the side mirrors 11a and 11b. Moreover, it is possible to set the evaluation image height to be an arbitrary evaluation image height by adjusting the positions of the side mirrors 11a and 11b.

### INDUSTRIAL APPLICABILITY

The present invention relates to an image pickup element position detection device that detects a positional relationship between an image pickup element and a lens which are to be mounted on an optical system device and face each other. The present invention can be applied to detection and adjustment of an axis deviation and an inclination between the image pickup element and the lens. Further, the present invention can also be applied to optical system devices such as a camera module and a microscope.

### REFERENCE SIGNS LIST

1 Substrate
2 Image Pickup Element
2a Opposing Mirror Reflection Image
2b Side Mirror Reflection Image
2c Side Mirror Reflection Image
3 Lens (Optical System)
4 Axis Deviation/Inclination Adjustment Section (Adjustment Section, Parallel Movement Section, Rotation Section)
5 Opposing Mirror
10A Image Pickup Element Position Detection Device
10B Image Pickup Element Position Detection Device
10C Image Pickup Element Position Detection Device
11a Side Mirror (One Side Mirror)
11b Side Mirror (The Other Side Mirror)
12a Opposing Mirror Moving Device (Opposing Mirror Moving Section)
12b Side Mirror Moving Device (Side Mirror Moving Section)
20 Detection Pattern
21 Light-Transmitting Section
22 Colored Section

1. An image pickup element position detection device that detects a positional relationship between an image pickup element and a lens which are to be mounted on an optical system device, the lens facing the image pickup element, said image pickup element position detection device comprising:
an opposing mirror which is disposed parallel to the image pickup element, the opposing mirror and the image pickup element being placed on opposite sides of the lens,
the image pickup element capturing an opposing mirror reflection image of the lens, the opposing mirror reflection image being an image of the lens which is reflected by the opposing mirror.

2. The image pickup element position detection device as set forth in claim 1, further comprising:
at least two side mirrors which face each other and are disposed (i) perpendicularly to the opposing mirror and (ii) on respective lateral sides of an area between the opposing mirror and the lens,
the image pickup element capturing a side mirror reflection image of the lens and another side mirror reflection image of the lens, the side mirror reflection image of the lens being an image of the lens which is reflected by first one of the two side mirrors, by the opposing mirror, and by second one of the two side mirrors in this order, and the another side mirror reflection image of the lens being an image of the lens which is reflected by the second one of the two side mirrors, by the opposing mirror, and by the first one of the two side mirrors in this order.

3. The image pickup element position detection device as set forth in claim 2 further comprising:
a detection object located between the lens and the opposing mirror, the detection object (i) being colored, (ii) having a light-transmitting section in a center of the detection object, and (iii) being disposed parallel to the opposing mirror.

4. The image pickup element position detection device as set forth in claim 1, further comprising:
an adjustment section that relatively adjusts positions of the image pickup element and the lens.

5. The image pickup element position detection device as set forth in claim 2, further comprising:
an opposing mirror moving section that moves the opposing mirror forward and backward, and
a side mirror moving section that moves the two side mirrors forward, backward, rightward, and leftward.
